(19) United States
(12) Patent Application Publication
(10) Pub. No.: US 2007/0018646 A1
(43) Pub. Date: Jan. 25, 2007

(54) Nmr leak test

(76) Inventor: Stephen Daniel Hoath, Cambridge (GB)

Correspondence Address: BARNES & THORNBURG LLP, P.O. BOX 2786, CHICAGO, IL, 60690-2786, US

(21) Appl. No.: 10/583,197

(22) PCT Filed: Dec. 9, 2004
(86) PCT No.: PCT/GB04/05160

§ 371 Date: Jun. 15, 2006

(30) Foreign Application Priority Data
Dec. 30, 2003 (GB) 0330154.6

(51) Int. Cl. G01V 3/00

(52) U.S. Cl. 324/307; 324/318

(57) ABSTRACT

Testing integrity of a barrier or a container uses NMR analysis. This is non-destructive and based on physical principles rather than chemical conversion or by signal suppression. It can use many alternative material forms, including solids, liquids, vapours and gases as appropriate to the application. Direct transfer into and accumulation within a NMR analysis system may be used by the NMR analysis system to determine from the accumulating material if there has been any leakage and whether this exceeds a pre-determined level without any added helium tracer. ¹⁹F NMR can be applied to testing for leakage of fluids with high % fluorine content, such as propellant from inhalers and also insulating gas from high voltage electrical systems, that are difficult, hazardous and or expensive to reliably detect directly by other methods and where the sensitive integrity validation of fluid-filled container production is required. NMR validation marking is also proposed.

### FIELD OF THE INVENTION

This invention relates to methods of testing integrity of a barrier, test equipment for validating container integrity, and products so validated by these methods or equipment.

### BACKGROUND TO THE INVENTION

Barriers and containers are often used to separate two or more materials from one another so as to permit use in a later application. For example, containers include those enclosures designed to maintain pressurised gas propellants above atmospheric pressure that are employed in certain asthma inhalers. Although a barrier need not be a complete enclosure and therefore is not itself a container, it may still be required to be integrity tested for incorporation or use within enclosures, for example where it is the most likely item to be leaking. In leak detection much attention is paid to containers, for gases and liquids, whereas a barrier rather than a container may be useful to separate solids from gases, and may even be used to filter coarser material against finer materials: seemingly integrity validation has need of new broad methods and test. By the above introduction a definition of containers would be barriers that completely enclose something and therefore in the descriptions given herein a container implies a barrier, but while barriers may imply containers they need not do so.

It is known to test the integrity of containers in applications such as production and field-testing of high voltage insulated electrical switchgear and the fast production line validation of pre-filled devices such as metered dose inhalers. The equipment type and the speed requirements for these applications are rather different, though both need reliable calibrated high sensitivity leak testing.

High voltage electrical switchgear and the like are most commonly filled at high pressure with SF₆, an insulating gas, in order to suppress electrical breakdown across conducting parts of the equipment. The equipment would fail in use if the pressurised content escapes, and as installations are intended for many years life in the field without any re-pressurisation, should that be feasible in practice, the leakage limitations are exacting at typically 3 cc of SF₆ per year. Methods for the detection of SF₆ leakage often involve the suppression of electrical corona discharge or of electron capture radioactivity that is caused by the leaking gas.

Among other issues, tightening safety regulations on movement of radioactive sources render this very sensitive ECD method less practical than it was once. Testing of equipment, using manual sniffing-type probes, can take hours of work, and is still highly reliant on the skill, training and attention of the operator and proper positioning of the sniffing-type probe relative to the equipment surfaces. In such testing only specific suspect joints are normally individually leak tested, so that validation of the whole equipment is not strictly established by “sniffing”.

Validating the integrity of pressurised devices such as metered dose inhalers (MDIs), is harder if they are filled with chlorine-free but fluorine containing propellants such as R134a or R227 (fire retardant FM200) that are relatively quite hard to detect compared with the previous generation of chloro- fluoro-carbon (CFC) propellants, that were used in MDIs, and containing at least one chlorine atom as well as a fluorine atom in their molecules.

The propellants are usually contained in liquid and gas phases within pressurised MDIs (pMDIs), and any defects in the containment allow gas and liquid propellant losses. The typical quality of pMDI production is better than 1 defective in 1 million devices, but should a pMDI lose too much propellant prior to usage before the “best by date”, the pMDI device will not be able to deliver the expected quantity of drugs to a user. Therefore methods are stipulated for every pMDI that is shipped for use by consumers.

The sensitivity required is specified by the regulatory bodies and agencies such as the American Food & Drug Administration (FDA) at about 0.5 g/year of HFA propellant, which translates to typical leakage rate of 4×10¹⁴ molecules per second or 2×10⁻⁵ mbarl/s at 21° C. These levels are themselves challenging for MDI production lines due to the speed of the filling processes and the accidental releases of propellant that inevitably occur nearby, and greatly reduced chemical activity of the CFC-replacement propellants.

Existing methods used for this purpose comprise either weighing the whole MDI after filling with the propellant at intervals of typically a week to 10 days or attempting to measure the gases lost with chemical sniffers or quadrupole analysers in production. Physical methods are better for propellants but conventionally require very fast readout of the measurement because of the speed of production, typically 100-200 MDIs per minute.

Grossly leaking MDIs, which lose propellant at high rates, are readily and usefully detected by simple means, but the validation to high sensitivity levels requires better techniques.

Accumulation chambers for the collection of leaking gases or liquids are used to help enhance the sensitivity of the methods used or proposed by the present author (see for example GB2376748, GB2376749 and GB2376750) for production line testing. Such chambers, placed around part or all of a can, allow for background by either pre-evacuation or signal subtraction methods, which may be in electronics or in software or a combination of the two approaches.

These accumulation chambers are either conventionally and permanently mounted on rotary table or indexing machines, and therefore have to be read out within the cycle time of the machine (within seconds) or, as proposed by the present author (see for example GB2376749 and GB2376750), loaded onto the production line itself with either cheap integral leak sensors on each chamber or a more expensive off-loading chamber reading station which effectively measures gases accumulated for a long time (in minutes) downstream of the chamber loading machine. Enhanced sensitivity relies on leakage accumulation in a chamber sealed to part of the surface or enclosing the item being tested.

NMR techniques are widely used with solid and liquid samples, but not with gases, because of the significant reduction of sensitivity and contrast available. A recent exception to this is the proposed use of hyper-polarised ³He (to enhance-sensitivity) diluted with air (to save cost at the expense of sensitivity gain) as a tracer gas to leak test a container, described in U.S. Pat. No. 6,626,027. In addition, the vast majority of NMR applications are used for scanning and imaging in medical or oil surveying and are based on proton detection not ¹⁹F detection, which is otherwise very similar in principle. There are however some specific non-scanning ¹⁹F NMR devices for fluoride toothpaste quality testing. The ¹⁹F isotope is present with 100.0% probability within a natural fluorine atom.

Small-bore low-field NMR analysis systems have a vertical magnet well to take a sample of solid or liquid material. The sample is weighed and placed in a tube then lowered into the well to determine the level of ¹⁹F present in the sample.

For the level of 25 ppm detected to 20% precision, the manufacturers of a ¹⁹F NMR analyser type MQA7019 by Oxford Analytical Instruments, UK have provided some analysis time estimates of 10 minutes, which might be reduced a bit by use of paramagnetic salts mixed with normal samples such as toothpastes and fluorine bearing minerals. Since, typically, the required HFA test time in a production test system is ˜1 second or less, use of conventional and available ¹⁹F NMR techniques appears to be limited to laboratory testing.

### SUMMARY OF THE INVENTION

An object of the present invention is to provide improved apparatus or methods. A first aspect of the invention provides a method of testing integrity of a barrier by transferring material from one side of the barrier through a continuous path directly into a NMR analysis system and using the NMR analysis system to determine from the transferred material if there has been any leakage through the barrier.

Some of the consequences of using a continuous path directly into a NMR analysis system are as follows: reduction of trapping or retention of transferred material within the isolation valves of conventional stepwise transfer systems for detection of low-levels of leakage, continuous material analysis for integrity validation purposes, reduction of the cost, maintenance requirements and complexity of the integrity validation system, and widening the range of materials and forms usable for leak detection and integrity validation purposes.

In systems with isolation valves, the seals of these valves or the valves themselves could provide trapping for the transferred material that can affect the outcome of the integrity testing, even if such valves were not actuated for the purpose of integrity testing. The valves would have to be sequenced and the normal valve actions would interrupt the flow of transferred material, so that continuous material analysis is prevented. Eliminating all valves eases these issues, provides a simpler cheaper validation system and alternative materials and forms for checking integrity of barriers using a NMR analysis system including pills, granules, powder, gels, liquids, gases and condensable vapours.

A second aspect of the invention provides a method testing integrity of a barrier by transferring material from one side of the barrier for accumulation within a NMR analysis system and using the NMR analysis system to determine from the accumulating material if there has been any leakage through the barrier.

The consequences of providing integrity testing by the suggested method includes the following: measurement of the leakage rate through the barrier over time, logging the leakage rate versus time for comparison with the logged placement times for materials located on the other side of the barrier, detection of gross leakage events through the barrier; detection of events such as material placements on the other side of the barrier (where the barrier acts as a partial filter for material); collection of the accumulated material for subsequent re-analysis; collection of the accumulated material for later analysis elsewhere; discrimination against apparently high leakage signals at or close to the very beginning of a barrier integrity test that can arise from backgrounds already present in the equipment; more reliable discrimination against random signals in NMR analysis systems; simpler equipment for integrity validation; alternative materials and forms for checking integrity of barriers using a NMR analysis including pills, granules, powder, gels, liquids, gases and condensable vapours.

A third aspect of the invention provides a method of testing integrity of a filled end product container that is filled with the end product material, by which material is transferred to an NMR analysis system in order to determine by using the NMR analysis system whether end product material has leaked from the filled end product container and whether the filled end product container is validated against a defined integrity value for such filled end product containers.

The consequences of providing integrity testing based on NMR leakage detection of the end product filling material include the following: test methods for end product containers that can only be acceptably tested after they have been formed, sealed and filled with the final end product filling; reduction of the cost and complexity of manufacturing and testing filled end product containers; integrity validation of filled end product containers against relevant regulations.

Whenever the end-product filling comprises dominantly of heavy molecules, choosing a NMR analysis method for filled end product container integrity validation would not have been obvious to leak detection specialists brought up on helium, hydrogen or radioactive fluid tracers as the most sensitive methods. Vacuum leak detection using hydrocarbon fluids exploits the gas dependency of ionisation gauges or detection by residual gas analysers or quadrupole mass spectrometers but measurement arrangements are required for validation work. The proposed methods based on NMR analysis can permit simple repeatable testing whereas the other techniques become more complex to implement.

We advocate exploiting using test materials normally present final end product container fillings, in other words without materials specifically introduced for the test purpose and no other. Such test material should normally contain a high percentage of detectable material to be of any value for integrity validation tests.

As an example, in pressurised containers such as pMDIs, the production of the filled end product container usually involves crimping a valve component onto a body component and filling the consequent container through the valve with a HFA or CFC propellant, both of which contain fluorine in the molecules. The valve may then be actuated as a check prior to validation of the integrity of the whole filled end product container. There is little point in using elaborate testing of the body and valve components separately by NMR testing because simpler means exist in prior art; however the filled end product container has to be integrity tested against FDA or similar standards if it is to be supplied to customers, there is advantage for a final test means using the end product filling material without additional materials required for such container integrity testing.

A fourth aspect of the invention provides a method for testing integrity of a barrier separating two materials by using a NMR analysis system to determine from the material on one side of the barrier if there has been leakage of material from the other side of the barrier without added helium tracer material.

Some of the consequences of a NMR analysis system for integrity testing of a barrier separating two materials without added helium tracer material include appropriate tests for barriers intended to separate two materials comprised only of larger forms, where penetration by helium material is not considered relevant for the barrier; a wider range of materials and forms usable for leak detection and integrity validation purposes; tracers comprised of heavier molecules for barrier integrity validation can be used for some barrier shapes to assist localisation of defects in the barrier because the tracer has slower speed of diffusion in air, compared with that of the lightest molecules; avoidance of issues with the helium material that is suitable for NMR analysis purposes, which is a rare isotope of helium primarily produced as the end-product of radioactive tritium decay; and new methods and techniques that are more routinely applied to product leak tests on production lines than is possible for helium tracer leak detection by any means.

Where helium tracer gas is a required test medium, alternative methods exist in prior art, and indeed the present author has inventive patents for helium mass spectrometer leak detection (see for example EP0668492 and U.S. Pat. No. 5,831,147). However there are many containment test applications where the materials used for testing the barrier integrity would ideally never involve helium tracer.

Using hyper-polarised helium material for routine leak test purposes neglects many practical realities for barrier integrity validation and would only be used for extreme requirements in the laboratory: in such cases normal helium gas and helium mass spectrometer leak detection would suffice for most applications, and there would be no need to use a hyper-polarised helium and NMR system.

Some consequences of using NMR systems without added helium material as proposed include simpler operation of the barrier integrity validation equipment; no extra preparation methods, materials, devices or heating required for use of hyperpolarised helium material; no extra cost for added helium NMR material.

The detection of leakage using NMR analysis is non-destructive and based on physical principles rather than chemical conversion or by signal suppression. Other techniques disrupt fluid molecules either physically or chemically or are, like weighing, physical tests that are non-selective for the materials involved.

NMR analysis is hitherto commonly used in medical or oilfield imaging, but it is not necessary to provide imaging NMR systems to detect fluid leakage, so that suitable analysis systems are far less expensive and elaborate than these and use can now be envisaged for more routine applications in industry.

NMR is also used for quantitative analysis of some atomic concentrations in minerals and products, but it is not necessary for the application to detect fluid leakage to provide NMR analysis systems having a vertical well geometry for the magnetic bore of the NMR analyser system: side entry NMR systems should be easier to integrate with normal production lines and sample flow through configurations can be considered.

Rare and special tracer gases such as hyper-polarised ³He have been recently proposed for leak testing by separate accumulation chamber means, but there are no prior suggestions for use of NMR techniques for barrier or container integrity testing relying on material or fluid types normally contained within them, or for direct transfer into the NMR analysis system or for continuous accumulation within the NMR analysis system, or for time dependent analysis of the NMR leakage signal, and no prior suggestions for use of ¹⁹F NMR applied to container integrity validation using fluids containing ¹⁹F or for marking the validated products following use of the proposed methods or the equipment.

The method of testing can be part of a method of making the product, or part of a method of using the product. The testing could be carried out in the industrial production of the product or as part of or following use of the product in the field.

In the method as set out above, material suspected of containing leakage from the container can be continuously transferred by a pumping means into the NMR analysis system.

Some consequences of this include the following: the NMR analysis system can be quite remote from the container to be validated; the transfer of material can be faster than without pumping; the material may be compressed into the NMR analysis system and a wider range of inlet pressures, not necessarily near atmospheric or vacuum, are available for material transfer.

In the method as set out above, as an additional feature, the pumping means may be a pressure pumping system.

Some consequences of this include the following: providing a test means where the barrier is to be tested at elevated pressures rather than vacuum or atmospheric pressure.

In the method as set out above, as an alternative additional feature, the pumping means may be a vacuum pumping system.

Some consequences of this include the following: providing for the many cases where integrity testing requires vacuum on the transfer side of the barrier.

In the method as set out above, as another alternative additional feature, the pumping means may be a combination of pressure pumping and vacuum pumping systems.

Some consequences of this include the following: where integrity testing requires vacuum on the transfer side of the barrier and the material delivery into the NMR analysis is at pressures above the typical output pressures from a vacuum pump system, or not near to atmospheric pressure.

In the method as set out above, as another additional feature, the NMR analysis system may be pre-evacuated prior to the start of accumulation.

Some consequences of this include the following: removal of material and the reduction of contamination from previous testing periods; better “zero” for the testing system.

In the method as set out above, as another additional feature, the NMR analysis system may be purged prior to the start of leak accumulation.

Some consequences of this include the following: removal of material and the reduction of contamination from previous testing periods; better “zero” for the testing system; wider range of material forms available to testing.

In the method as set out above, as another additional feature, the NMR analysis system may be both purged and pre-evacuated prior to the start of accumulation.

Some consequences of this include the following: removal of material and the reduction of contamination from previous testing periods; better “zero” for the testing system; wider range of material forms available to testing.

In the method as set out above, as another additional feature, the NMR analysis system may be equipped with one or more sensors or detectors.

Some consequences of this include the following: the quantity of material present in the NMR analysis system can be determined, perhaps due to the excess pressure, or weight, built up in the NMR analysis system, or sensed by using an optical means or a chemical sensor means, which is of value in determining the end point for leakage accumulation.

In the method as set out above, as another additional feature, the NMR analysis system does not have to start analysis immediately the accumulation is initiated.

Some consequences of this include the following: accumulation within the NMR analysis system eliminates the need to make an conventional accumulation chamber move into the NMR analysis system, but the NMR analysis system would not, at the very start of accumulation, normally contain detectable levels of material unless there was a very large initial fluid leakage from the container.

In the method as set out above, as another additional feature, the NMR analysis system can include analysis parameters that are designed to take into account the elapsed accumulation time or NMR analysis system filling rate.

Some consequences of this include the following: provision for the time dependent changes of the density of the material in the NMR analysis system; the results from the NMR analysis system will vary with elapsed time of leakage accumulation, either as the container exhausts its content or as the accumulation chamber gets pressurised to a limiting pressure level.

In the method as set out above, as an additional feature, the container may comprise an electrical component charged with insulating gas, and the testing comprise testing for leakage of insulating gas that is difficult and or expensive to reliably detect directly by other means already used or proposed for testing integrity.

Some consequences of this include the following: avoiding radioactive detection means and the use of high voltage discharges; testing for leakage of insulating gas from an electrical component using NMR analysis can be directly related to levels specified in the electrical industry.

In the method as set out above, as an alternative additional feature, the container may comprise an inhaler, and the testing comprises testing for leakage of propellant from the inhaler. The inhaler contains propellants that are difficult and or expensive to reliably detect directly by other methods already used or proposed for testing integrity.

Some consequences of this include the following: testing for leakage of propellant from an inhaler using NMR analysis can be directly related to the validation of dispenser integrity sought by the FDA rules and requirements for the production of highest quality metered dose inhalers.

The method as set out above may have a step of accumulating propellant leakage in a separate accumulation chamber.

Some consequences of this include the following: in conventional NMR systems, the sample composition is fixed and a known weight of it is dispensed into a sample tube or similar while in the proposed method an accumulation step permits the content of the separately collected sample to change over time; in some embodiments this can enable NMR analyses to be applied before, during and or after such separate accumulation, to ensure that the accumulation can be determined and assigned to leakage.

In the method as set out above, as an additional feature, the separately accumulated fluid material can be extracted and transferred by a pumping means into the NMR analysis system.

Some consequences of this include the following: the NMR analysis system can be quite remote from the container to be validated; the transfer of material can be faster than without pumping; the material may be compressed into the NMR analysis system and a wider range of inlet pressures, not necessarily near atmospheric or vacuum, are available for material transfer.

In the method as set out above, as an additional feature, the pumping means may be a pressure pumping system.

Some consequences of this include the following: providing a test means where the barrier is to be tested at elevated pressures rather than vacuum or atmospheric pressure; operation at a distance from the NMR analysis system.

In the method as set out above, as an alternative additional feature, the pumping means may be a vacuum pumping system.

Some consequences of this include the following: providing for integrity testing requiring vacuum on the transfer side of the barrier.

In the method as set out above, as another alternative additional feature, the pumping means may be a combination of pressure pumping and vacuum pumping systems.

Some consequences of this include the following: where integrity testing requires vacuum on the transfer side of the barrier and the material delivery into the NMR analysis is at pressures above the typical output pressures from a vacuum pump system, or not near to atmospheric pressure.

The container under test is not usually moved with its own accumulation chamber right into the NMR analyser bore: for inhalers they could be moved together, although practice this is unlikely and is impractical for larger vessels. However if the accumulated material is in fluid form it may be extracted by a suitable pumping means and exhausted to the analysis system, thereby avoiding any need to move an accumulation chamber into the analyser.

In the method as set out above an inhaler or an electrical component charged with insulating gas may contain fluorinated compounds and the NMR analysis involves detecting fluorine atoms in such compounds.

Some of the consequences of this include the following: inhaler propellants commonly used usually contain several fluorine atoms in each molecule, which enhances the sensitivity of the integrity testing when the NMR analysis involves detecting fluorine; other methods are generally sensitive to the number of molecules, not atoms, of a particular component of leakage, or not specific to the containment of the propellant but to the inhaler; an advantage of the proposed method is that both CFC and HFA propellants are detectable by NMR analysis, unlike chlorine -specific CFC tests; an electrical component for high voltages may be charged with SF₆ insulating gas, which has high fluorine content detectable by a NMR analysis system means.

In the method with separate accumulation as set out above some or all of the material accumulated in the accumulation chamber may be extracted by a pumping means and subsequently transferred into the NMR analysis system.

Some consequences of this include the following: since the tiny quantity of accumulated gas is transferable from the accumulation chamber quite efficiently by pumping means, and pumping means will provide a compressed output, it will often be expedient to use one pumping system both for extraction and delivery into the NMR analysis system, after a suitable accumulation period in a separate chamber.

In the method with separate accumulation as set out above the transfer of the accumulated chamber contents may be into one or more special containers for NMR system analysis, from which the contents themselves are then extracted and exhausted by a pumping system into the NMR analysis system.

Some consequences of this include the following: since the accumulated gas contents can be extracted and exhausted, and the accumulation chamber may be part of a part handling system, it will often be expedient to use special containers designed as appropriate for NMR analysis rather than accumulation from a product.

In the method with separate accumulation as set out multiple numbers of accumulation chambers may be extracted into single or multiple special NMR analysis system chambers for simultaneous NMR analysis.

Some consequences of this include the following:

In the method with separate accumulation as set out above some part or all of the accumulation chamber may be subsequently moved into the NMR analyser.

Some consequences of this include the following: since the separate accumulation chamber may be much smaller than the NMR analyser system or sited some way away from it, it will often be expedient to move the separate accumulation chamber partly or wholly into the NMR analyser system after a suitable separate accumulation period.

In the method with separate accumulation as set out above transferring the separate accumulation chamber contents into a second container for analysis, which is itself then moved into the NMR analyser system.

Some consequences of this include the following: the NMR analyser system usually has an external magnetic “fringing” field surrounding the NMR magnet especially near the bore such that magnetic materials of construction of the separate accumulation chamber also have to be kept away from it, so use of a second container for analysis is significant in avoiding this magnetic disturbance which might thereby compromise or reduce the sensitivity of the NMR analysis system; second containers for analysis can be manufactured to optimise their fit and material content (both magnetic and to minimise background signal) within the NMR analysis system without the constraints placed on the shape and size of the separate accumulation chamber to fit around the container being integrity validated inside They can be smaller and be handled and transferred far more readily. The second containers can optionally be pre evacuated to reduce contamination risk for example

In the method with separate accumulation as set out above multiple numbers of these second containers or separate accumulation chambers may be NMR analysed simultaneously.

Some consequences of this include the following; with the possibility of having second containers for analysis that are not only shaped and constructed with appropriate materials for the NMR analysis system and of smaller size than separate accumulation chambers for all products, testing of separately accumulated leakages from different containers simultaneously by loading the second chambers (or separate accumulation chambers) into the NMR analysis system together, possibly by transferring these containers stepwise through the bore of the NMR analyser system as each untested second container for analysis or separate accumulation chamber becomes available, where the size of the second container or separate accumulation chamber and the bore of the NMR analysis system is so constructed to enable such items to pass through.

The methods as set out above may have the step of cooling the leakage.

Some consequences of this include the following: by cooling the leakage collected from containers, the leakage material volume can preferentially reach and remain in locations within or near to the NMR analysis section. This may thereby enhance the proportion of molecules in the NMR analyser and improve the leak detection sensitivity; this is particularly useful for condensable fluids because materials analysis by NMR methods is normally performed in solid state or liquid, not vapour states, and most significantly for low levels of fluid leakage where condensation does not occur or is physically unlikely at low concentrations outside the container.

The methods set out above may have the step of accumulating leakage on a cooled surface and measuring the amount accumulated.

Some consequences of this include the following: making measurements on the accumulating leakage on a cooled surface is that the amount accumulated can be compared with a pre-determined threshold value, which signifies a non-compliant level of leakage; the actual leakage rate of a container can be determined to low very level by continuing the cooled leakage accumulation, which may be helpful in the establishment of the actual production margins for a batch or a particular design of container against any applicable standards.

The method as set out above and including cooling may have the step of moving the cooled surface relative to an NMR analysis system, to carry out the measurement after a period of separate accumulation.

Some consequences of this include the following: there may be many containers to be tested by one or just a few NMR analysers, said containers being produced in such number or at a high rate needing a significant number of separate accumulation chambers each fitted with cooled surface(s) moved appropriately into and out of the analyser.

The method as set out above including the separate accumulation of leakage may have the step of pre-evacuating the separate accumulation chamber.

Some consequences of this include the following: the removal or reduction of surface spills, gross fluid leakage or background contamination prior to starting the accumulation period; the evacuation means provided might incorporate detectors that are based on chemical detection of gross fluid leaks, so that the control of the container filling and sealing and or background levels can be alerted to poor conditions independently of an NMR analysis; the likely faster migration of the propellant molecules through the leak path and around the inhaler body placed inside the separate accumulation chamber; enhancement of the fluid leakage rate through any defects in the container.

Another aspect of the invention provides test equipment means for validating container integrity using a NMR analysis system for analysis of leakage accumulated within a separate chamber.

Provision of such test equipment significantly improves the basis for validation of containers such as metered dose inhalers over high-speed weight checkers that have to be used to compare the weight of such products at different dates and eliminates or significantly reduces the warehousing requirements needed.

The test equipment as set out above may be applied where the propellant contains at least one fluorine compound and the NMR analysis is for ¹⁹F nuclei contained within the propellant molecules.

Since HFA propellants have been replacing the CFC propellants, the common chemically based CFC leak detection products have had much less sensitivity and great difficulty in providing validated products. HFA molecules all contain fluorine atoms, each of which has a ¹⁹F nucleus available for ¹⁹F NMR analysis, and there is a significant %F by weight in common HFA molecules, so that the test equipment is favourable to the detection of HFA propellant leakage. Since CFC products also contain fluorine atoms they are also favourably detected by the test equipment, with the advantage that the test equipment can handle integrity validation for CFC and HFA filled MDIs without added difficulty.

The test equipment as set out above may have a cooled surface and means for transferring accumulated propellant leakage to the NMR analysis system.

The cooled surface helps accumulation of propellant in a location or on a surface that is suitable for transfer to the NMR analysis system. The means for transferring accumulated propellant leakage to the NMR analysis system only need transfer a part of the accumulation chamber rather than both the chamber and the container under test, and therefore provides the advantage that this part is only a fraction of the size and weight of the accumulation chamber: this may be incorporated into a small bore NMR analysis system, which itself will be smaller and more economic to provide and fit into production facilities.

The transfer means may include an intermediate container that transfers the accumulated propellant leakage (with or without cooling in the accumulation chamber) into another chamber (with or without cooling surface) more suitable for insertion into the NMR analysis system. Such an intermediate container may be combined with others, to provide a simultaneous assessment means when integrity test throughput is demanding and the testing sensitivity is proven adequate.

Alternatively, the transfer means may be a pumping system that transfers the accumulated propellant leakage (with or without cooling) from one or more accumulation chambers into one or more chambers (with or without cooling surface) for NMR analysis without the need to move any chambers. Either vacuum pumping or pressure pumping or a combination of these could be used.

A transfer type vacuum pump provides a transfer means for the accumulated leakage material in the case of propellants and insulating gases by extraction from the accumulation chamber and exhaustion into the NMR analysis chamber without the need for physically moving any chamber into the NMR for analysis. An advantage of the new feature arises because the accumulation and analysis chambers require rather different optimal designs for their intended function.

The test equipment as set out above may have means for pre evacuating the accumulation chamber.

The pre-evacuation means permits the elimination or reduction of room background and or surface contamination of the fluid container prior to the subsequent accumulation period in order to avoid attributing these to leakage from the fluid containers. This room background or surface contamination is quite likely to occur during earlier production steps for the fluid filled containers.

The test equipment as set out above may have a cooling means comprising a Peltier effect device.

Peltier or thermoelectric devices do not require the use of cryogenic fluids, thereby providing a convenient cooling means for the test equipment to enhance the NMR signal and or help localise the accumulated propellant. Other cooling means, for example a heat pipe, may also be used to transfer heat from the cooling surface to the Peltier-effect or thermoelectric device.

The test equipment as set out above may be constructed using a material for the chamber to provide a calibration means for the NMR analysis system.

It is a significant advantage to incorporate a material within or made part of the chamber designed to have material providing an NMR reference signal that can be detected as a means of proving test equipment sensitivity with every test, which thereby enhances the reliability of the integrity validation.

Alternatively, a known special chamber with material providing such calibration means can be introduced into the NMR analysis system to demonstrate the test equipment sensitivity as required, or regularly, to establish such testing.

Alternatively, fluid reference material could be introduced from a calibration sample accumulation chamber into the NMR analysis system by the very same or similar pumping means as for the sample leak testing, avoiding any need to move chambers, to demonstrate the test equipment sensitivity as required, or regularly, to establish such testing against known levels.

The test equipment as set out above may provide a means for cross checking integrity validation with an off-line NMR analysis system

This system can be run in parallel with the normal NMR system for checking product on a batch basis or after a hiatus in the normal production testing.

By ensuring that the off-line testing can also handle the accumulated products normally tested by the on-line test system, different measurement periods can be employed in the off-line NMR analysis system in order to establish the actual leakage, surface contamination or room backgrounds with advantage.

The provision of a compatible NMR analysis system may provide an economic means of increasing throughput or minimising downtime, although since the NMR system itself need have no moving parts or cryogenic cooling for the NMR magnet field generation means (since this is not necessary in the application).

Another aspect of the invention provides a product validated by any of the methods or test equipment as set out above.

The validation of fluid filled high voltage electrical components by any of the methods or test equipment as set out above confers a high level of integrity both for the product and also its production.

An electrical product could be given a mark to show it has been validated by any of the methods or test equipment as set out above.

The validation of an inhaler product by any of the methods or test equipment as set out above confers a high level of integrity both for the inhaler and also its production, thereby meeting requirements of the FDA or other regulatory bodies for the demonstration of the required performance of every container used for inhaler products and also for production means of inhaler products.

An inhaler product could be given a mark to show it has been validated by any of the methods or test equipment as set out above.

A considerable advantage of marking an inhaler product that has been validated by the method or equipment is that the value of the product to the user and producer is enhanced by openly showing that it has been directly assessed by NMR techniques, which link to the well-respected, publicly known and high valued MRI (medical resonance imaging) techniques.

The inhaler product that is validated by any of the methods or test equipment as set out above, could have the validation mark on packaging of the inhaler product.

Likewise another advantage of marking the packaging of an inhaler product so validated by the method or equipment is that it conveys an association of high value inhaler products with publicly known MRI techniques and results, justified because the method or equipment used is based on NMR analysis.

A product that needs to be validated may require some documentation or advertisements and these could carry the NMR validation mark as appropriate.

While the main purpose of the invention is integrity testing of containers, for CFC-replacement propellants such as used within pMDIs, that are generally hand-held cans having overall dimensions of a few centimetres or inches, it is clear that many other container integrity applications could adopt the approach.

All devices containing fluorinated compounds are testable using this method, though the test equipment will be far bigger and slower for fire extinguishers using FM200 than for R227 pMDI testing machines, even though FM200 is the same compound as R227. Other fluorinated compounds used extensively by industry, including SF₆ used in high voltage switchgear, could be detected.

Industrial devices containing SF₆ are not moveable, so the application of the invention to them most likely requires transportable fluorine NMR analysis and transfer system with an accumulation chamber partially covering the product.

Heavier-than-air insulating gas from a leaking product might be accumulated in hoods surrounding all high voltage and pump feed-through parts of an SF₆ switchgear held on suitable lifting gear well above the leak testing system and allowed to flow by gravity into a vertical well fluorine NMR analysis system, or alternatively collected from the accumulation hood and exhausted into the analysis system by means of a transfer type vacuum pump as described above.

For barriers rather than containers, gravity-fed systems could be appropriate for testing filters for solid materials, using either solid or liquid forms as NMR test materials, emphasising the broad nature of the approach to integrity validation now possible with the approaches described for end-product filled containers.

Other advantages will be apparent to those skilled in the art, particularly over any other prior art not yet known to the inventor. The additional features can be combined with each other and with any of the aspects as would be apparent to those skilled in the art.

### BRIEF DESCRIPTION OF THE DRAWINGS

Embodiments of the invention will now be described to show by way of example how it can be implemented, with reference to the figures in which:

FIG. 1 shows some principal features of an embodiment using NMR analysis.

FIG. 2 shows some principal features of another embodiment.

FIG. 3 shows some principal features of another embodiment involving an inhaler and an accumulation chamber.

FIG. 4 shows some principal features of another embodiment involving an inhaler with a fluorinated propellant and an accumulation chamber.

FIG. 5 shows some principal features of another embodiment involving material collection 58 with direct transfer 78 into a continuous NMR analysis system 28.

FIG. 6 shows some principal features of another embodiment with the steps of accumulation 60 prior to transfer step 70 prior to the NMR analysis.

FIG. 7 shows some principal features of another embodiment with the steps of pre-evacuation 30, stabilisation 110 and cooled accumulation 100 prior to transfer step 90 into a second container for analysis step 80.

FIG. 8 shows some principal features of another embodiment with the steps of introducing a calibration chamber 105, loading an inhaler step 65, accumulation step 60, transfer step 70, NMR analysis step 20, post test transfer step 75 and off-line NMR analysis step 25.

FIG. 9 shows some principal features of an embodiment of the test equipment with a cooled endplate 102 forming one wall of the accumulation chamber 6 and also an NMR analysis system 222 having another endplate 101 from an earlier test shown enclosed by lid 78 within tube 441 in sample well of magnet 4.

FIG. 10 shows some principal features of another embodiment of the test equipment with inhalers 32 held within accumulation chambers 6 above endplates 102 mounted on pallets 170 moved by a production line transfer means 150.

FIG. 11 shows some principal features of another embodiment of the test equipment with leakage transfer achieved using transfer type vacuum pumping.

FIG. 12 shows some principal features of another embodiment that validates or rejects an inhaler product by the method or test equipment using NMR.

### DETAILED DESCRIPTION OF THE DRAWINGS

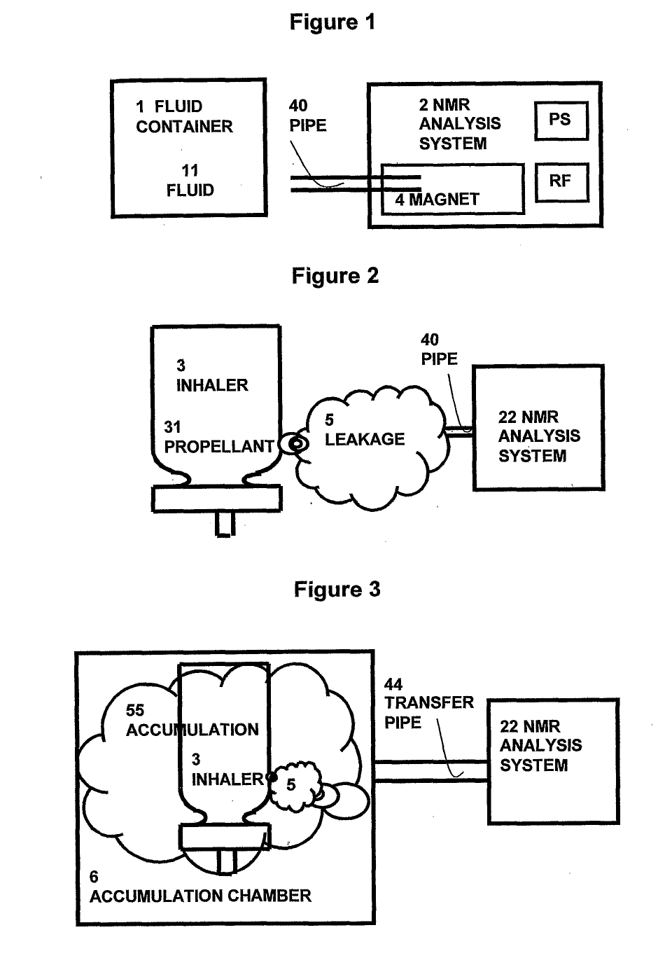

FIG. 1 shows a container 1 containing fluid 11 and an NMR analyser system means 2 used for integrity testing of the fluid container 1. The pipe 40 connects to the sample well in the bore of the magnet 4 within the NMR analysis system 2. This analysis system also has a power supply PS and a radio-frequency RF section as used for NMR techniques.

FIG. 2 shows a container means that is an inhaler 3 containing an end product container filling including propellant 31 and an NMR analysis system means 22 used for integrity testing of the inhaler by detection of the propellant fluid 5 leaking from the inhaler 3 via the sample pipe 4 which directly transfers material into the NMR analysis system.

FIG. 3 shows a container means that is an inhaler 3 placed within an accumulation chamber means 6 such that NMR analysis system means 22 used for integrity testing of the inhaler detects the accumulation 55 of the propellant fluid 5 leaking from the inhaler 3 via the transfer pipe 44.

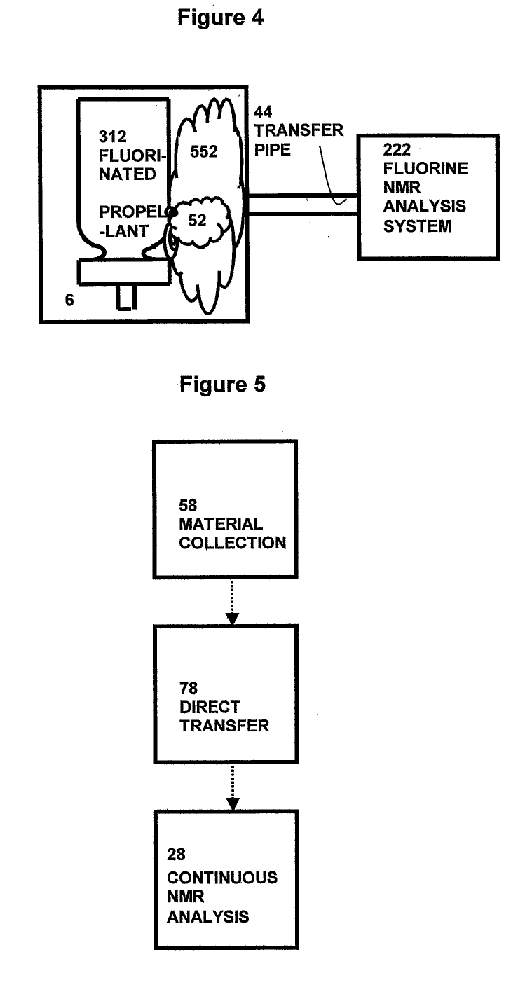

FIG. 4 shows a container means that is an inhaler 32 containing fluorine compounds placed within an accumulation chamber means 6 such that NMR means 222 that is sensitive to fluorine is used for integrity testing of the inhaler detects the accumulation 552 of the fluorine compound containing propellant fluid 52 leaking from the fluorine compound containing inhaler 32.

FIG. 5 shows the material collection means 58 with a direct transfer means 78 into the continuous NMR analysis system 28. This direct transfer means 78 can have a continuous path directly into the NMR analysis system with or without a transfer-type pumping means (not shown separately). The continuous NMR analysis system 28 may or may not have an accumulation section for the material (not shown separately). The collection means 58 may or may not have a sniffing probe means, or a partial hood means or an accumulation chamber means for the barrier or container being validated (none are shown separately).

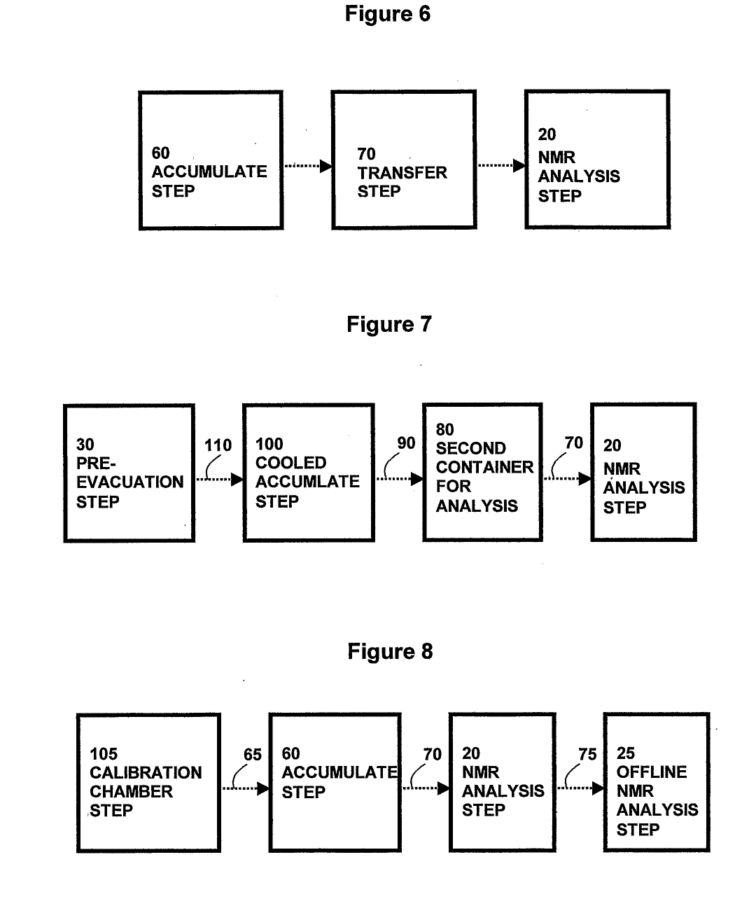

FIG. 6 shows the accumulation step 60 and the transfer step 70 prior to the NMR analysis step 20. The transfer step 70 usually takes place after sufficient time in the accumulation step 60 for the accumulation from any leakage at a predetermined threshold level that still just maintains the container integrity to be reliably detected by the NMR analysis step 20. There may be accumulation losses at the transfer step 70 that have to be compensated by additional accumulation time or increased NMR sensitivity.

FIG. 7 shows the pre-evacuation step 30 of the chamber and stabilisation step 110 prior to the cooled accumulation step 100 and a transfer step 90 to a second container for analysis 80 prior to a second transfer step 70 of the second container into the NMR analysis system for the NMR analysis step 20. The pre-evacuation step 30 may apply to the accumulation chamber or to the second container for analysis or both in order to reduce or eliminate the level of detectable contamination otherwise introduced by the level of room background or by the container leakage prior to the timed accumulation step. Pre-evacuation step 30 may assist faster transport of the leakage into the chamber by reduction of transit time for molecular diffusion across its spaces. The pre-evacuation step may enhance the level of fluid leakage from the container if it is faulty, for example due to a mal-positioned actuation valve seat or a poor body crimp seal. The pre-evacuation step 30 might well include detection based on chemical detection of gross propellant leaks, so that the control of the container filling, valve crimping and or background levels can be alerted to poor conditions independently of NMR analysis step 20 and also somewhat faster. Peltier or thermoelectric devices do not require the use of cryogenic fluids, thereby providing a convenient cooling means for the test equipment to enhance the NMR signal and or help localise the accumulated propellant. Other cooling means, for example a heat pipe, may also be used to transfer heat from the cooling surface to the Peltier-effect or thermo-electric device. The cooled plate may have absorbents for the propellant in order to help the concentration of the accumulation onto a compact region that is easier to transfer and analyse in another chamber. The stabilisation step 110 between pre-evacuation step 30 and cooled accumulation step 100 is sometimes required to cover transient periods during or immediately after rapid chamber evacuation and also for the proper preparation of the cooled plate forming part of the accumulation chamber wall. The accumulation step 100 may now be longer than before if transfer step 90 has accumulation losses in addition to any losses in transfer step 70.

FIG. 8 shows the calibration chamber step 105 and transfer step 65 prior to accumulation step 60 and transfer step 70 into NMR analysis step 20, transfer step 75 and off-line NMR analysis step 25. It is a significant advantage to incorporate a material within or made part of the chamber designed to have material providing an NMR reference signal that can be detected as a means of proving test equipment sensitivity with every test, which thereby enhances the reliability of the integrity validation. Alternatively, as shown, a known special chamber with material providing such calibration means can be introduced into the NMR analysis system to demonstrate the test equipment sensitivity as required, or regularly, to establish such testing. This can provide a means for cross checking integrity validation with an off-line NMR analysis system. This system can be run in parallel with the normal NMR system for checking product on a batch basis or after a hiatus in the normal production testing. By ensuring that the off-line testing can also handle the accumulated products normally tested by the on-line test system, different measurement periods can be employed in the off-line NMR analysis system in order to establish the actual leakage, surface contamination or room backgrounds with advantage. The provision of a compatible off-line NMR analysis system may provide a significant economic means of increasing throughput or minimising downtime.

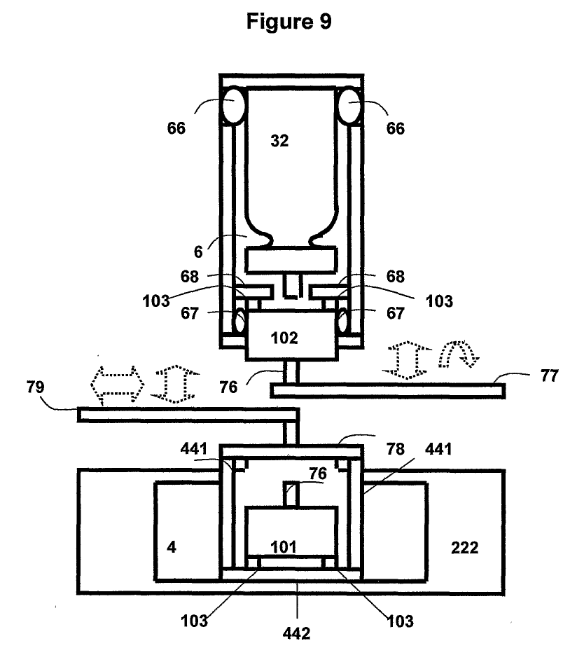

FIG. 9 shows another embodiment of the test equipment with a cooled endplate 102 forming one wall of the accumulation chamber 6 and also an NMR analysis system 222 having another endplate 101 from an earlier test shown enclosed by lid 78 within tube 441 onto sample well base 442 of magnet 4. Endplate movement means 77 and lid movement means 79 are shown. Standoffs 103 are short spacers providing some thermal barriers for cooled endplates 102 and 101 otherwise in contact with the accumulation chamber 6 and the sample tube 441 through the chamber spacers 68 and sample well base 442 respectively. Flexible coupling means 76 was detached from the endplate movement means 77 and placed with endplate 101 within the second chamber for analysis that has been formed in this embodiment partially inside NMR system 222 by lid 78, tube 441 and sample well 442. After the testing of endplate 101, lid 78 is removed by lid movement means 79 to permit extraction and placement of 101 into another accumulation chamber using another endplate movement means (not shown for clarity). The endplate movement means 77 then places 102 onto 442, decouples from flexible coupling means 76 and then the lid movement means 79 places lid 78 onto tube 441 ready for 222's next NMR testing step.

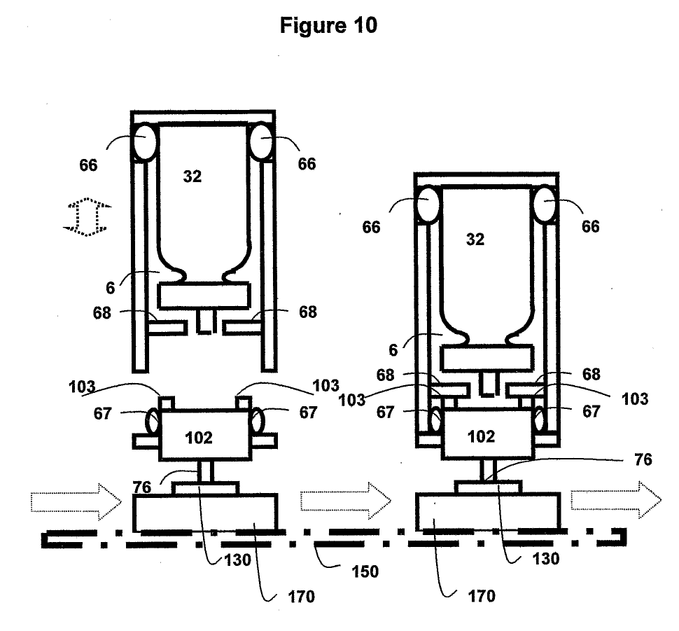

FIG. 10 shows another embodiment of the test equipment where some inhalers 32 are held upside down by means of O-ring type seals 66 within accumulation chambers 6 above endplates 102 mounted by a short flexible coupling means 76 and the endplate cooling, pre-evacuation, accumulation transfer and venting means 130 on small pallets 170 moved by a production line transfer means 150. Spacers 68 and 103 of the accumulation chamber 6 are provided to help retain the inhaler 32 and provide location for the endplate device when the chamber is fully closed up. The accumulation chamber 6 is moved down onto the end plate 102 and makes a close fitting enclosure around the inhaler 32 by means of seals O-ring type seals 67. A reverse of this procedure can be adopted using this equipment for extracting the endplate from the accumulation chamber after the accumulation has been transferred to a second chamber for analysis and the accumulation chamber has been vented through means 130.

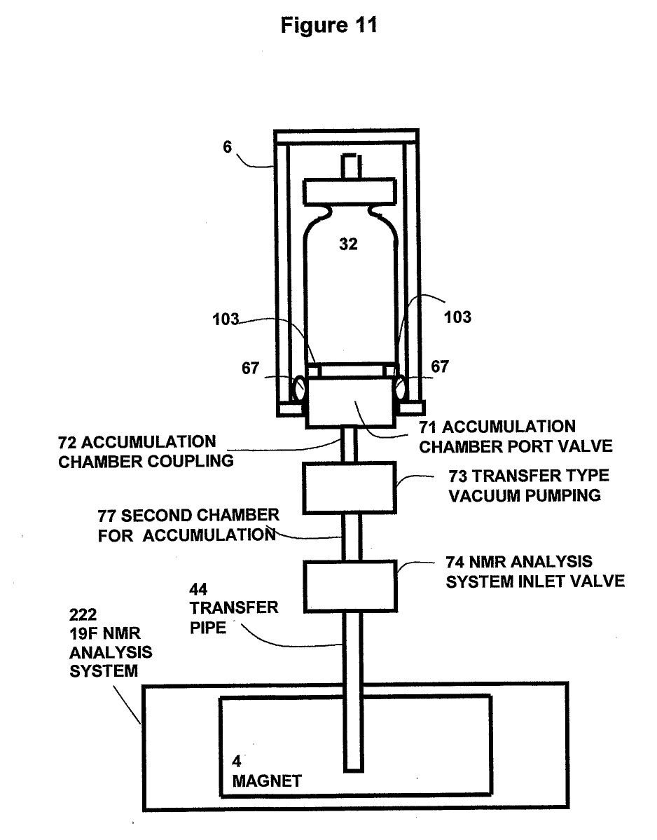

FIG. 11 shows an embodiment of the test equipment in which the transfer of the accumulated leakage from an inhaler 32 is achieved using a transfer type vacuum pumping system 73 between the transfer port valve 71 of the accumulation chamber coupling 72 and the inlet port valve 74 for an NMR analysis system 22. The components of the ¹⁹F NMR analysis system 222 are essentially as earlier described for NMR analysis system 2. Likewise, apart from the changed orientation of the inhaler 32 from those shown in FIGS. 9 & 10, there are similar components with similar functions to form the enclosure around the inhaler 32, such as the O-ring seals 67 and standoff spacers 103. The vacuum pumping system 73 extracts the accumulated leakage within chamber 6 through open valve 71 and delivers the compressed gases into the coupling 72. The inlet port valve 74 may be open or shut as required for this transfer. When the valve 74 is open the contents of the accumulation chamber coupling 72 communicate via the second chamber for accumulation 77 with the ¹⁹F NMR analysis system 222. This transfer port valve 71 may then be closed. When the transfer port valve 71 is shut the accumulation chamber 6 may be removed; this can take place before the NMR analysis is completed, or even started, provided a transfer has already taken place from the accumulation chamber 6 into the accumulation chamber coupling 72 by the transfer type vacuum pumping means 73. The transfer pipe 44 ends inside the bore of the magnet 4 within the NMR analysis system, fed from the second chamber for accumulation 77 by means of NMR analyser system inlet valve 74. Transfer into the NMR system 222 proceeds in the known manner if the valve 74 is opened.

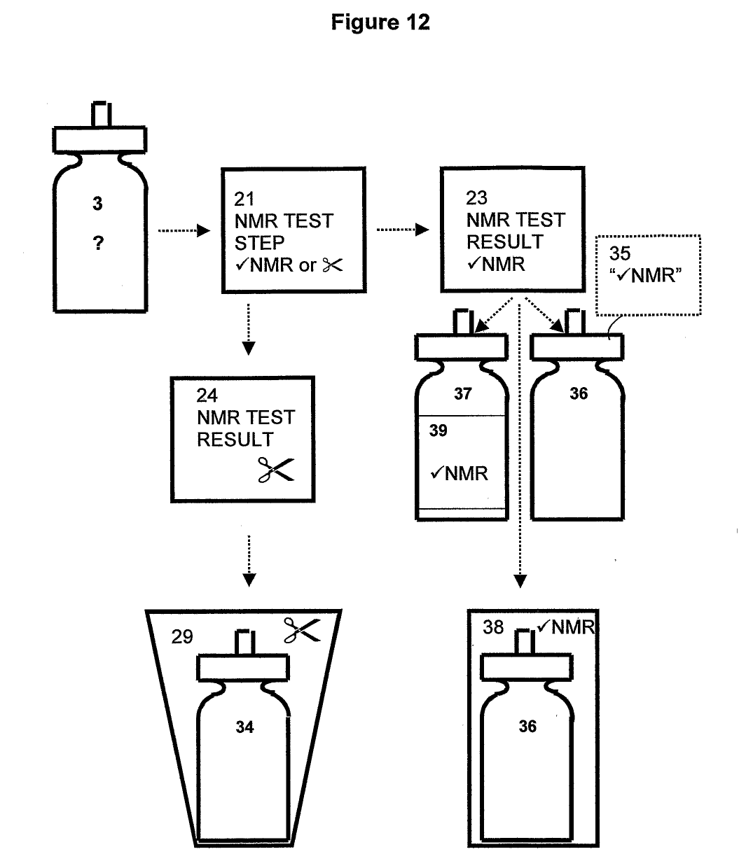

FIG. 12 shows how the application of NMR test step 21 to an untested inhaler item 3 used to validate or reject an inhaler product by the method or test equipment using NMR results in either a pass NMR test result 23 or a failed NMR test result 24. Failed NMR test result 24 results in the corresponding tested inhaler 34 being consigned to the NMR test reject bin 29. Pass NMR test result 23 results in corresponding tested inhaler 36 being validated as a pass NMR, for example it is then known individually as a “✓NMR” 35 type of product. Alternatively tested inhalers 37 and 36 with pass NMR test results could be marked with a ✓NMR label 39 or be placed into packaging with ✓NMR mark 38. The validation of an inhaler product by any of the methods or test equipment as set out above confers a high level of integrity both for the inhaler and also its production, thereby meeting requirements of the FDA or other regulatory bodies for the demonstration of the required performance of every container used for inhaler products and also for production means of inhaler products. Marking any resultant passed ✓NMR inhaler product itself or even packaging of an inhaler product so validated by the method or equipment conveys an association of high value inhaler products with publicly known MRI techniques and results, justified because the method or equipment used is based on NMR analysis.

As has been described above, testing integrity of a filled product fluid container uses ¹⁹F NMR analysis. This is non-destructive and based on physical principles rather than chemical conversion or by signal suppression. It can be applied to testing for leakage of propellant from inhalers containing fluorinated propellants that are difficult and or expensive to reliably detect directly by other methods. Accumulation in the NMR analysis system increases the number of propellant molecules or atoms available for detection, usually in proportion to the length of the period used for accumulation, thereby increasing the number density being NMR analysed for barrier integrity validation by means of the NMR detection of low-level leakage.

Accumulated gaseous leakage can be handled efficiently and without moving chambers by a transfer type vacuum pump exhausted into the NMR analyser chamber. Propellant leakage can be accumulated by condensing on a cooled surface in a pre evacuated chamber to increase the number of propellant molecules or atoms available for detection, usually in proportion to the length of the period used for accumulation, thereby providing a faster analysis for validation by detection of absence of even low-level leakage. Other variations can be envisaged within the scope of the claims.

1-39. (canceled)

40. A method of testing integrity of a barrier by transferring material from one side of the barrier through a continuous path directly into a NMR analysis system and using the NMR analysis system to determine from the transferred material if there has been any leakage through the barrier.

41. A method of testing integrity of a barrier by transferring material from one side of the barrier for accumulation within a NMR analysis system and using the NMR analysis system to determine from the accumulated material if there has been any leakage through the barrier.

42. A method of testing integrity of a filled end product container, that is filled with the end product material, by using a NMR analysis system to determine whether end product material has leaked from the filled end product container and using this determination to validate the filled end product container.

43. The method of claim 41 without using a helium tracer added to the material.

44. The method of claim 40 in which a pumping system is used to transfer materials into the NMR analysis system.

45. The method of claim 40 and using a sniffing probe means that can be moved relative to the surface of the barrier so as to allow materials to be collected from different positions relative to the barrier for transfer into the NMR analysis system.

46. The method of claim 40 where a hood chamber at least partially covers and is sealed to the barrier or container surface so as to allow material from this section of the barrier or container surface to be collected for transfer into the NMR analysis system.

47. The method of claim 42 where the container comprises any of: electrical equipment charged with a fluid, and an inhaler charged with end product filling materials including propellant fluid, and the testing comprises testing for leakage of this fluid from the container.

48. The method of claim 42 having a step of accumulating leakage in a separate chamber prior to the transfer to the NMR analysis system.

49. The method of claim 48 where the accumulation of material for analysis also occurs within the NMR analysis system.

50. The method of claim 40 where some or all of the fluid material contains fluorine compounds, and the NMR analysis involves detecting fluorine.

51. The method of claim 48, having any of the steps of: moving the accumulation chamber into an NMR analysis system; transferring the accumulation chamber contents into a second container for analysis and then transferring the second container contents into an NMR analysis system; and transferring the accumulation chamber contents into a second container for analysis and then moving this container for analysis into an NMR analysis system.

52. The method of claim 40, having the step of carrying out the NMR analysis for multiple barriers, multiple containers, or both types, simultaneously.

53. The method of claim 40 having any of the steps of: cooling the materials;
accumulating leakage on a cooled surface then measuring the amount accumulated;
accumulating the leakage on a cooled surface located within the NMR analysis system, to accumulate materials directly within the NMR analysis system, and accumulating the leakage on a cooled surface and moving the cooled surface relative to an NMR analysis system, to carry out the measurement after a period of accumulation.

54. The method of claim 48, having the step of evacuating the chamber that is to be used for accumulation prior to transfer into the NMR analysis system before accumulating material leakage.

55. Test equipment having means for validating inhaler integrity using a NMR analysis system for analysis of material leakage accumulated within the NMR analysis system.

56. The test equipment according to claim 55 having any of: a transfer type vacuum pumping system means for transferring material leakage into the NMR analysis system, a pressure pumping system means for transferring material leakage into the NMR analysis system, and a transfer type vacuum and pressure pumping system combination for transferring material leakage into the NMR analysis system.

57. The test equipment according to claim 55 arranged to transfer the accumulated material to another chamber means for introduction into the NMR analysis system for analysis of the leakage.

58. The test equipment according to claim 55 where the fluid is fluorine containing and the NMR analysis is for ¹⁹F nuclei contained within the fluid molecules.

59. The test equipment according to claim 55 having a cooled surface and apparatus for transferring material accumulated on the cooled surface to the NMR analysis system.

60. The test equipment according to claim 55 arranged to pre evacuate the accumulation chamber.

61. The test equipment according to claim 59 whereby the cooling surface comprises a Peltier effect device.

62. The test equipment according to claim 55 and having a calibrator arranged to use a material of the chamber to provide a calibration means for the NMR analysis system.

63. The test equipment according to claim 55 having apparatus arranged to cross check integrity validation with an off-line NMR analysis system.

64. A product validated by the method of claim 42.
